(19) United States
(12) Patent Application Publication
(10) Pub. No.: US 2003/0229654 A1
(43) Pub. Date: Dec. 11, 2003

(54) PDASync - a synching method between a PDA (Personal Digital Assistant) client or clients and a host computer supporting one-to-many and many-to-one database synchronization

(75) Inventors: Charles Bibas, Searingtown, NY (US); Zion Shivat, Tel Aviv (IL)

Correspondence Address: Advanced Barcode Technology, Inc., 525 Northern Blvd., Great Neck, 11021

(73) Assignee: ADVANCED BARCODE TECHNOLOGY, INC., Great Neck, NY (US)

(21) Appl. No.: 10/250,054

(22) Filed: May 30, 2003

Related U.S. Application Data
(60) Provisional application No. 60/387,402, filed on Jun. 10, 2002.

(51) Int. Cl. G06F 12/00

(52) U.S. Cl. 707/203

(57) ABSTRACT

PDASync is a module that allows a handheld computing device to communicate with a database running on a host computer. When the PDA is returned to its docking cradle, or is in wireless range, the Sync application, running on a PC, allows the user to select a database which will then have its data updated with data stored on the PDA, and vice-versa.

### BACKGROUND OF INVENTION

Radio-frequency (RF) is a very widely used method for providing real-time transfer of information between handheld devices and central computers. However, there are drawbacks. Without purchasing special equipment (repeaters, antennas, etc.), the signal range is not very long. Also, any environments which require the users to be on the road, for instance trucking, are not capable of employing RF solutions. Furthermore, RF signals are very prone to interference. If someone is working with a radio frequency device in such an inhospitable environment, there is a good chance that data will not reach its destination.

This situation can be avoided by employing a batch process, whereby data is stored on the handheld unit until the unit is docked into a cradle connected to a desktop or laptop computer via a serial or USB interface, or even through a wireless connection. Any data can then be synched back to the PC.

This invention employs batch processing to allow data incorporated locally on the handheld to be synched back to the database on the desktop/laptop. It accomplishes this by creating a table on the handheld which is a subset of a database table on the desktop. Only the fields which are needed by the handheld are included in the table. Data is written to a corresponding table on the PC, then a set of basic instructions is executed which moves data from this temporary table into the actual data table.

### SUMMARY OF INVENTION

It is the object of this invention to allow a primary database, stored on a host computer (laptop device or desktop device) to be updated with information stored in a database on a handheld computer (PDA). The data on the handheld can be updated as well.

Please note: The secondary database is not of the same structure or type as the primary database. Therefore, PDASync will work with any database types.

### DETAILED DESCRIPTION

The solution is based on having a local copy or a subset of the Host (Desktop/Server) database in the PDA. The Synch process should function based on the following:

1. Host Sync program will keep track of tables that are read only for the PDA. Sync program will synch these tables from Host to PDA only.

2. All database PDA operations will be written to a log file (table) as well as to the local database. Host Synch program will read the log file from the PDA and re-run it on its own database. That way there is no actual synchronization between the Host Tables and the PDA Tables. What there is a re-run of the PDA operations on the Host data base. The result is updated tables in the Host. After Host tables were updated, the Host will now update the PDA with one way Synch (any record that is different or missing will be re-written by the Host into the PDA, this is done by having a version column).

Collision can be handled automatically or by Admin. The Host will merge the Log file from the PDA to the Host Log file either by direct merge or by induced merge (via the re-run).

Terms and More Definitions:

Log file (table): The log file includes information of all fields (from all tables) that can be changed by the PDA plus a time stamp. Any operation that change a field or fields in the PDA will also add new entry to the log file and fill the value(s) of the changing fields in this new log file entry, in addition a time stamp value will populate this new entry, all other unchanged fields will remain blank (all blank fields are a signal to the Host not to change these fields).

Data type: Handling of more complex data as pictures, PDF, doc etc. can be done by saving them in a folder while the PDA database field will point to them. The type is not important, since the file name extension will indicate what program/function to use to open it. These fields will be saved as a files as follows: <column_name>.<fieldname>.<type>. For instance, if in the host we have a database named MyDB with a Table named Items an a column name Image with the value of a picture Mypicture,jpg then this will be stored in the PDA as: root\MyDB\Items\Image.Mypicture.jpg. The PDA will save the path for this in the corresponding field.

The host synch process will update these files from the host database to the PDA in a standard sync fashion (any file that have been changed will be replaced).

What is claimed is:

1. A system for synchronizing data between one or more primary databases and one or more secondary databases comprising:
a primary database, stored on a host computer;
a secondary database, stored locally on a handheld computing device, or PDA;
a program interface, stored on and run from the host computer, which allows the user to select which primary database is to be synchronized with the secondary database, then performs the operation automatically at timed intervals and/or at the command of the user.

2. The system of claim 1 wherein the secondary database is in a different format from the primary database.

3. The system of claim 1 further comprised of a docking station for the handheld device. The handheld must either be docked, or be within wireless range, for the synchronization process to take place.

4. The system of claim 1 wherein data from the secondary database is written into a special table in the primary database.

5. The table of claim 4 wherein the data in said table is translated as a series of instructions which will re-create the data to be stored in the primary database.

6. The system of claim 1 wherein only records created in the secondary database subsequent to the previous synch procedure will be used in the current synch procedure.

7. The sequence of instructions in claim 5 are standard database operations which are compiled into the Sync program in claim 1.

8. The system of claim 1 wherein data from the primary database is written to the secondary database, bringing it up to date.

9. The system of claim 8 is regulated by a version number, where if the version numbers in the primary and secondary databases are the same, no operation is performed, but if the numbers differ, the data record is copied from the primary to the secondary.

10. The system of claim 8 is further governed by rules which are set by the administrator and stored in the primary database. Whether or not these rules are activated is determined by the version number in claim 9.
